(19) United States
(12) Patent Application Publication
(10) Pub. No.: US 2004/0163571 A1
(43) Pub. Date: Aug. 26, 2004

(54) Fire door core assembly

(75) Inventor: Andre Fortin, Lennoxville (CA)

Correspondence Address: DIEDERIKS & WHITELAW, PLC, Suite #301, 12471 Dillingham Square, Woodbridge, VA, 22192, US

(73) Assignee: DORSET FIREDOOR SYSTEMS, INC.

(21) Appl. No.: 10/687,607

(22) Filed: Oct. 20, 2003

Related U.S. Application Data
(60) Provisional application No. 60/443,555, filed on Jan. 30, 2003.

(51) Int. Cl. C04B 12/04; C04B 14/12; C04B 16/08; C04B 28/26; C04B 35/16; C04B 38/00

(52) U.S. Cl. 106/605

(57) ABSTRACT

A fire resistant wood door is formed from an opposing pair of rails interconnected by a upper and lower stiles forming an outer frame. A wood laminate core is provided within the outer frame and covered by outer sheathing. The wood laminate core is formed from first and second panels and a heat barrier layer. Each of the first and second panels is formed from an organic material and provided with a plurality of grooves on one surface. The heat barrier layer is in the form of a casting applied to the grooved surface of at least one, and preferably both, of the first and second panels. The panels are then joined together with the heat barrier layer sandwiched therebetween. When joined with the outer frame and sheathing, a wood door is formed having a fire rating of at least 45 minutes.

### CROSS-REFERENCE TO RELATED APPLICATION

This application claims the benefit of the filing of U.S. Provisional Patent Application Serial No. 60/443,555 filed Jan. 30, 2003.

### BACKGROUND OF THE INVENTION

1. Field of the Invention

The present invention pertains to the art of doors and, more particularly, to the construction of a fire resistant door.

2. Discussion of the Prior Art

Doors for commercial, and even domestic, applications are often rated for fire resistance. More specifically, fire doors are rated based on their ability to resist burning in the case of a fire, with standard ratings being defined as 20, 45, 60 and 90 minutes depending on the length of time a door can withstand a rating temperature, typically in the range of 1700+° F. The higher the minute rating, the better the fire rating. For instance, low rated fire doors are typically made from an organic material, while high rated fire doors are generally made from mineral or metal materials. More specifically, a 20 minute door typically includes a particle or stave board core. For 45, 60 and 90 minute ratings, a wood door generally has a mineral core.

In general, the higher rated fire doors have more costly constructions. That is, while a particle board core having a density per cubic foot in the range of about 28 to 32 pounds can be easily produced without generating much dust as compare to a mineral core, is relatively inexpensive to utilize, and can be conveniently cut to desired sizes, particle board materials simply have not been able to be utilized to produce high rated fire doors. Certainly, it would be a significant advantage to be able to produce a high rated fire door from less expensive materials which are readily available, low in weight, high in mechanical strength, and easily machined.

Based on the above, there exists a need in the art for a fire door which can be economically produced, while still exhibiting a superior level of fire resistance. More specifically, there exists the need for a way to employ lower rated and less expensive fire resistant materials to produce fire doors having enhanced fire ratings.

### SUMMARY OF THE INVENTION

The present invention is directed to producing a fire door which exhibits a relatively high rating, while incorporating a core material made from a material previously dedicated for use in connection with lower rated fire doors. More specifically, the present invention is concerned with making a fire door having a core formed from an organic material, preferably a particle core, and a fire rating level of at least 45 minutes.

In accordance with the invention, a fire door includes a core including multiple panels of particle board having sandwiched therebetween a relatively thin casting of an heat insulating barrier that exhibits adhesive qualities. In accordance with the most preferred form of the invention, each one of a pair of particle board panels is initially prepared by being directed through a panel rip saw or the like which forms a plurality of thin grooves therein. The sides of the panels having the grooves are then coated with a fire retardant layer of casting material, such as perlite, gypsum, vermiculite, clay, refractory cement or the like. Once the casting material, which is bonded together with a binding material and can include a reinforcing filler such as chopped glass fibers or a fiberglass mesh, is applied so as to fill the grooves and coat the surfaces of the panels, the two panels are laminated together and pressed to a desired thickness. If necessary, the panels can be placed in a cold press until fully dried or cured. The laminated panels can then be trimmed to be used as a core in making a specified sized door.

With this construction, a fire door can be constructed with a fire rating level of at least 45 minutes out of particle board which has heretofore been restricted for use in connection with making 20 minute rated doors. Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a partial sectional view of a portion of a fire door constructed in accordance with the present invention;

FIG. 2 is a cross-sectional view of the core of the fire door of FIG. 1; and

FIG. 3 is a perspective view illustrating a system for producing the fire door core of FIG. 2.

### DETAILED DESCRIPTION OF THE PREFERRED EMBODIMENT

With initial reference to FIG. 1, a fire door constructed in accordance with the present invention is generally indicated at 2. As shown, door 2 includes an outer peripheral frame 5, constituted by interconnected rails, an upper one of which is shown at 7, and stiles, one of which is shown at 8; a core 11; an inner door skin 14; and an outer door skin 15. In general, the above construction of door 2, with the exception of the particulars of core 11, is known in the art. Therefore, these aspects of door 2 will not be discussed further here in detail.

The present invention is particularly directed to the construction and method of forming core 11. In general, core 11 constitutes a laminate including a first panel 20, a second panel 21 and an intermediate heat barrier layer 23. In accordance with the most preferred form of the invention, each of first and second panels 20 and 21 is formed from an organic material, preferably particle board and, more preferably, softwood, hardwood, wheat, straw, flax shaves, and/or sugar cane fiber. On the other hand, intermediate heat barrier 23 constitutes a casting material, such as perlite, gypsum, vermiculite, clay, refractory cement or the like, which is bonded together with a binding material and can include a reinforcing filler such as chopped glass fibers or a fiberglass mesh.

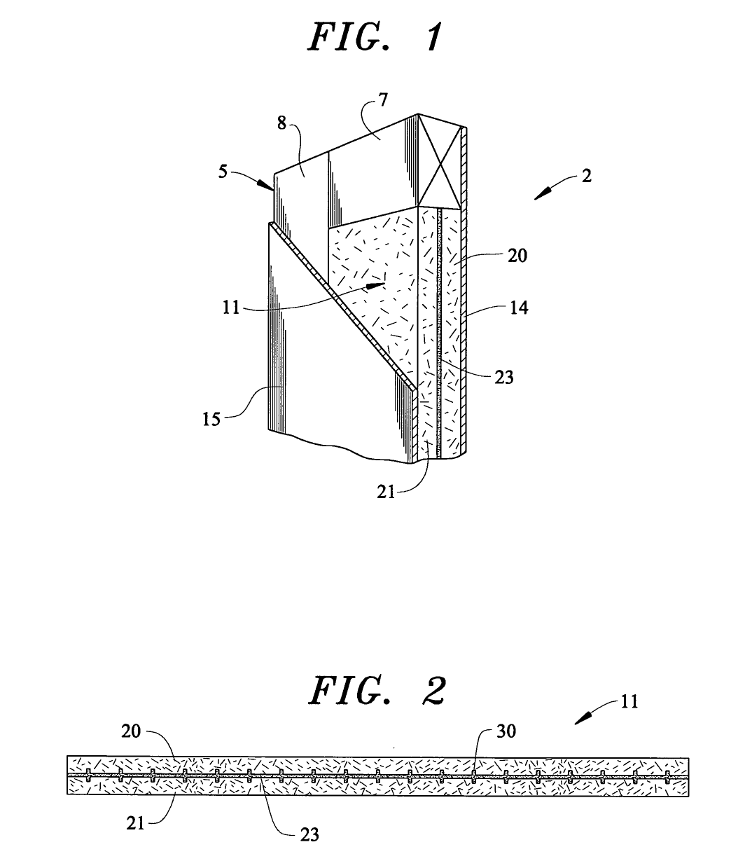

In further accordance with the present invention, first and second panels 20 and 21 are provided with a series of grooves 30 as best represented in FIG. 2. As shown, grooves 30 extend longitudinally along the entire length of only one planar side surface of each panel 20, 21, while the opposing planar side surface is substantially free of any grooves so as to define a uniform planar surface. In the most preferred form of the invention wherein core 11 is made to a standard thickness of 1.5 inches (38 mm), grooves 30 are preferably spaced center-to-center in the order of 1-4 inches (approximately 25-102 mm), more preferably 1.5-3 inches (approximately 38-76 mm) and most preferably 1.5 inches (38 mm); have a depth of approximately 1/4 inch (6 mm); and exhibit a width of about 0.125 inches (3 mm). Each of first and second panels 20, 21 have a thickness in the order of 0.688 inches (17 mm) and are spaced by intermediate heat barrier 23 in the order of 0.125 inches (3 mm). Of course, these distances and dimensions are merely presented in connection with a preferred embodiment of the invention such that they can be readily altered in connection with forming other standard door thicknesses and/or custom designs.

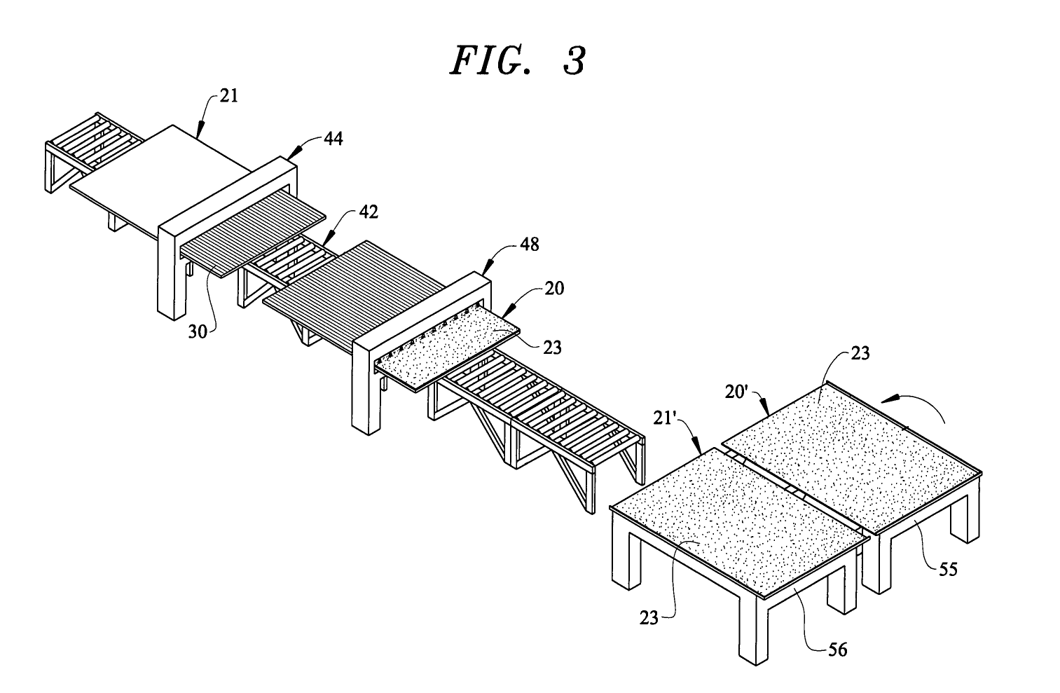

FIG. 3 illustrates a preferred manner of forming core 11 in accordance with the invention. In general, each of first and second panels 20 and 21 are placed upon a conveyor 42 and initially directed through a panel rip saw 44 for use in connection with forming grooves 30. Next, each of first and second panels 20, 21 are directed through a coating apparatus 48 at which the first and second panels 20 and 21 are coated with heat barrier layer 23. In general, this step can be performed in various ways, including spraying, pouring, painting and the like. In any case, the heat barrier layer 23 is applied so as to fill grooves 30 and coat respective surfaces of first and second panels 20 and 21. Thereafter, the panels are transferred to tables 50 and 56 as illustrated in FIG. 3 with respect to previously coated panels 20′ and 21′. At this point, one panel 20′, 21′ can be covered with a thin fiberglass mesh (not shown). Preferably, heat barrier layer 23 is allowed to cure in order to have a paste-like consistency. As indicated by the arcuate arrow in this figure, panel 21′ is then flipped atop panel 20′. In this manner, panels 20′ and 21′ are laminated together to form core 11. Although not shown, the panels 20′ and 21′ can be pressed to a desired thickness. For instance, core 11 could be placed in a cold press until fully dried or cured. Core 11 can then be trimmed on any or all of its four sides for use in making a specified sized door 2, such as with the addition of frame 5 and inner and outer door skins 14 and 15.

With this arrangement, it has been found that the particle core 11 achieves at least a fire rating level of 45 minutes. Although particle board was heretofore limited for use in connection with making 20 minute fire doors, the addition of the heat barrier 23 establishes a special thin casting that has been found to reduce burning. Therefore, a relatively inexpensive door 2 can be formed in accordance with the present invention which exhibits low weight, high mechanical strength, exceptional bonding with a wide range of adhesives, the ability to readily be cut to various sizes, easy machining characteristics, and low dust generation during machining as compared to more expensive mineral cores and the like. The inclusion of grooves 30 enhances the mechanical strength of heat barrier 23, which defines a separating layer for panels 20 and 21 while also extending into the body of each panel 20, 21. In addition, with the casting material of intermediate heat barrier layer 23 extending into grooves 30 in each panel 20, 21, the invention ensure that the casting material will remain as long as possible to the particle board panel 20, 21 on the unexposed side of a burning door 2, thereby further reducing heat penetration through door 2.

Although described with reference to a preferred embodiment of the invention, it should be readily understood that various changes and/or modifications can be made to the invention without departing from the spirit thereof. For instance, although grooves 30 in accordance with the most preferred embodiment of the invention are constituted by spaced, longitudinally parallel cuts, it is possible in accordance with the invention to provide additional cross or angled cuts, or even to rout grooves in other configurations. In addition, instead of spraying or pouring heat barrier 23 on panels 20 and 21, heat barrier 23 could be defined by a preformed sheet that is placed between and adhered to panels 20 and 21, along with a thin casting or adhesive still filling grooves 30. In any case, it should be readily apparent that a fire door constructed in accordance with the present invention can be made in various ways to produce a door having a relatively high fire rating from materials which have only been previously utilized in connection with lower rated fire doors.

I claim:

1. A fire resistant wood door comprising:
an outer peripheral frame; and
a two panel wood laminate core including:
a first panel formed from an organic material including first and second opposing planar surfaces and a plurality of grooves, said grooves being formed in the first planar surface of the first panel;
a second panel formed from an organic material including first and second opposing planar surfaces and a plurality of grooves, said grooves being formed in the first planar surface of the second panel; and
a heat barrier layer arranged between the first planar surface of the first panel and the first planar surface of the second panel, said heat barrier layer being formed from a flame resistant casting extending into the plurality of grooves of each of the first and second panels, wherein the first and second panels are pressed together with the heat barrier layer sandwiched therebetween to form the two panel wood laminate core, said two panel wood laminate core being arranged within the outer peripheral frame to form a door having a fire rating of at least 45 minutes.

2. A two panel wood laminate core for a fire resistant door having a fire rating of at least 45 minutes comprising:
a first panel formed from an organic material including first and second opposing planar surfaces and a plurality of grooves, said grooves being formed in the first planar surface of the first panel;
a second panel formed from an organic material including first and second opposing planar surfaces and a plurality of grooves, said grooves being formed in the first planar surface of the second panel; and
a heat barrier layer arranged between the first planar surface of the first panel and the first planar surface of the second panel, said heat barrier layer being formed from a flame resistant casting extending into the plurality of grooves of each of the first and second panels, wherein the first and second panels are pressed together with the heat barrier layer sandwiched therebetween to form the two panel wood laminate core for use in a door having a fire rating of at least 45 minutes.

3. The wood laminate core according to claim 2, wherein the organic material of each of the first and second panels is constituted by particle board.

4. The wood laminate core according to claim 2, wherein the organic material of each of the first and second panels is selected from the group consisting of: softwood, hardwood, wheat, straw, flax shaves and sugar cane fiber.

5. The wood laminate core according to claim 2, wherein the flame resistant casting is selected from the group consisting of: perlite, gypsum, vermiculite, clay and refractory cement.

6. The wood laminate core according to claim 2, wherein the heat barrier layer includes a binding material.

7. The wood laminate core according to claim 2, wherein the heat barrier layer includes a filler material.

8. The wood laminate core according to claim 7, wherein the filler material is selected from the group consisting of: chopped glass fiber and fiberglass mesh.

9. The wood laminate core according to claim 1, wherein the plurality of grooves extend longitudinally across the first planar surface of each of the first and second panels.

10. The wood laminate core according to claim 9, wherein adjacent ones of the plurality of grooves are separated by approximately 1-4 inches (approximately 25-102 mm).

11. The wood laminate core according to claim 10, wherein adjacent ones of the plurality of grooves are separated by approximately 1.5-3 inches (approximately 38-76 mm).

12. The wood laminate core according to claim 11, wherein adjacent ones of the plurality of grooves are separated by approximately 1.5 inches (approximately 38 mm).

13. The wood laminate core according to claim 2, wherein each of the plurality of grooves has a width and a depth, said depth being approximately 0.25 inches (approximately 6 mm) and said width being approximately 0.125 inches (approximately 3 mm).

14. The wood laminate core according to claim 2, wherein the heat barrier layer is approximately 0.125 inches (approximately 3 mm) thick.

15. The wood laminate core according to claim 2, wherein the core has a density of approximately 25-32 pounds per cubic foot.

16. The wood laminate core according to claim 2, wherein the core has a thickness of approximately 1.5 inches (approximately 38 mm).

17. A method of forming a two panel fire resistant wood door core comprising:
creating grooves on one side of a first panel formed from an organic material;
creating grooves on one side of a second panel formed from an organic material;
coating the one side of at least one of the first and second panels with a casting material to form a heat barrier layer; and
joining the first and second panels with the heat barrier layer being sandwiched between the first and second panels and extending into the grooves to form a wood laminate core for use in making a dual panel door having a fire rating of at least 45 minutes.

18. The method of claim 17, further comprising: adding a binding material to the casting material prior to coating the one side of the at least one of the first and second panels.

19. The method of claim 17, further comprising: covering the one side of at least one of the first and second panels with a reinforcing material prior to joining the first and second panels.

20. The method of claim 17, wherein joining the first and second panels constitutes cold pressing the first and second panels together to a desired thickness for the laminate core.

21. The method of claim 20, wherein the first and second panels are cold pressed to the desired thickness of approximately 1.5 inches (approximately 38 mm).

22. The method of claim 17, further comprising: trimming the wood laminate core to a desired size.

23. The method of claim 22, further comprising:
mounting the wood laminate core in an outer peripheral frame; and
applying outer sheathing panels to opposite sides of the wood laminate core to form a door having a fire rating of at least 45 minutes.

24. The method of claim 17, wherein the heat barrier layer is sprayed onto the one side surface of each of the first and second panels.

25. The method of claim 17, wherein the heat barrier layer is poured onto the one side surface of each of the first and second panels.

26. The method of claim 17, wherein the heat barrier layer is formed approximately 0.125 inches (approximately 3 mm) thick.

27. The method of claim 17, wherein the grooves are created on one side of each of the first and second panels by directing each of the first and second panels through a rip saw.

28. The method of claim 27, wherein adjacent grooves in each of the first and second panels are spaced by approximately 1-4 inches (approximately 25-102 mm).

29. The method of claim 17, wherein each of the plurality of grooves is formed with a width and a depth, said depth being approximately 0.25 inches (approximately 6 mm) and said width being approximately 0.125 inches (approximately 3 mm).

30. The method of claim 17, further comprising: forming each of the first and second panels from particle board.
